(19) United States
(12) Patent Application Publication
(10) Pub. No.: US 2026/0356143 A1
(43) Pub. Date: Nov. 12, 2026

(54) FUNCTION DEVICE FOR A MOTOR VEHICLE, IN PARTICULAR A REAR COVER FOR A REAR-SIDE RECEPTACLE, FIXED TO THE VEHICLE, OF A TOWING DEVICE FOR A MOTOR VEHICLE

(71) Applicant: BOS GmbH & Co. KG, Ostfildern (DE)

(72) Inventors: Mickey HANNAN, Shelby Township, MI (US); Satya Akhil Reddy BACHUGUDAM, Rochester Hills, MI (US)

(21) Appl. No.: 19/670,184

(22) Filed: May 7, 2026

Related U.S. Application Data
(60) Provisional application No. 63/802,706, filed on May 9, 2025.

(51) Int. Cl. B60D 1/60

(52) U.S. Cl. CPC B60D 1/60

(57) ABSTRACT

A function device, in particular a rear cover for a rear-side receptacle associated with a towing device and fixed to a motor vehicle. The function device has a function part, in particular a covering element which in a closed position covers the receptacle and in an open position exposes the receptacle. The function device additionally includes a control mechanism mounted on a carrier structure fixed to the vehicle and mechanically coupled to the function part to move the function part between two end positions. A push-push control is associated with the control mechanism and locks the function part in the two end positions or releases the function part for transfer to the other end position.

### CROSS-REFERENCE TO RELATED APPLICATION

This claims priority from U.S. Provisional Application No. 63/802 706, filed May 9, 2025, the disclosure of which is hereby incorporated by reference in its entirety.

### TECHNICAL FIELD

The invention relates to a function device for a motor vehicle, in particular to a rear cover for a rear-side receptacle, fixed to the vehicle, of a towing device for a motor vehicle, having a function part, in particular a covering element, which is movable between two different end positions by means of a control mechanism mounted on a carrier structure, fixed to the vehicle and is mechanically coupled to the function part, in particular to the covering element.

### BACKGROUND AND SUMMARY

A rear cover for a rear-side receptacle, fixed to the vehicle, of a towing device for motor vehicles is known. Such a motor vehicle has on its rear side a rectangular tube, fixedly connected to a bodywork carrier structure, which serves as a receptacle for inserting and securing a towing element of a towing device. With the towing element removed, and accordingly during non-use, the receptacle of the rectangular tube is closed by a covering element.

One object of the invention is to provide a function device of the type mentioned at the outset which is of simple design and is convenient to use.

This is achieved in that a push-push control is associated with the control mechanism and locks the function part in either of the two end positions or releases it for transfer to the other end position. The push-push control in accordance with the invention permits both a simple structure and firm securing of the function part in each end position, and nevertheless convenient movement of the function part, in particular of the covering element, into the other end position. An additional motor-powered drive unit can effect an automatic movement of the function part into the other end position. The push-push control also permits the securing of the function part in each end position. A four-joint mechanism is preferably provided as the control mechanism, which carries the function part, in particular the covering element. The function part is moved by means of the four-joint mechanism along a curved path between the closed position and the open position. Alternatively, other variants of a control mechanism may be provided. A covering element for a rear cover is preferably manufactured as a curved shell, preferably made of plastic. The covering element not only covers the receptacle of the towing device, but also extends both in the vertical direction and in the transverse direction—relative to a vehicle coordinate system—beyond the receptacle in the closed position. Preferably, the covering element is inserted flush into a recess of a rear fender of the motor vehicle in the closed position. In the open position, the covering element is preferably swung downwards in the vehicle vertical direction and forwards in the vehicle longitudinal direction. The push-push control is activated by manual pressure onto the covering element and against the required movement direction. After activation of the push-push control, the function part is free to be moved into the other end position. For securing and releasing the function part, the push-push control uses a function principle which is known per se from ballpoint pens for moving a ballpoint pen refill between two different positions. The solution in accordance with the invention is provided for all types of function parts inside a vehicle interior or exterior of a motor vehicle which are movable between two different end positions. The solution in accordance with the invention is used particularly advantageously for a rear cover of a receptacle of a towing device for a motor vehicle. The solution in accordance with the invention is suitable particularly advantageously for wheeled vehicles in the form of passenger cars, preferably pickup vehicles, or commercial vehicles or trucks which are provided at the rear of the vehicle with corresponding receptacles, fixed to the vehicle, for a towing device.

In one embodiment of the invention, the push-push control is designed rotational. This embodiment means that a cardioid shape, defining the push-push control, of the forced control is effective in the circumferential direction, and hence rotationally and not linearly, as is the case with the ballpoint pen principle. The cardioid shape is here curved in the circumferential direction, so that the corresponding push-push control can be enabled during a rotary movement. The push-push control is thus associated with a rotational function element of the control mechanism, preferably to a rotational function element which exerts a drive function for the control mechanism.

In a further embodiment of the invention, the push-push control is associated with a rotatable drive shaft extension of the control mechanism. The push-push control is provided on a drive shaft extension at the end of a drive shaft, so that the push-push control can be positioned on the outside of the control mechanism. This enables easy fitting or removal of the push-push control. It is also possible due to this embodiment to retrofit the push-push control to an existing control mechanism for a function part.

In a further embodiment of the invention, the push-push control has a control cam, co-rotating with the drive shaft extension, which is provided with a cardioid slotted guide on its outer circumference. The slotted guide may be designed as a groove or ridge. Advantageously, the outer circumference is designed cylindrical, and the cardioid slotted guide extends in the circumferential direction along this outer circumference.

The rotational design of the push-push control combines a forced control in the rotation direction with a forced movement in the axial direction. To provide a rotational operative connection to the control mechanism, the push-push control must be designed co-rotating with the control mechanism. This is the case since the control cam is designed co-rotating with the drive shaft extension of the control mechanism. The forced movement in the axial direction is assumed by a control pin described in the following, which is axially movable relative to the control cam.

In a further embodiment of the invention, the control cam has a cylindrical outer circumference, and the cardioid slotted guide is provided as a slotted guide groove in the outer circumference. The control cam thus forms a control roller, on whose outer circumference the cardioid slotted guide groove is provided. This control roller is co-rotating with the drive shaft extension.

In a further embodiment of the invention, the push-push control has a control pin which projects into the cardioid slotted guide and is mounted with limited back-and-forth movability. The design of the control pin is adjusted to the cardioid slotted guide such that a positive forced movement results between the control pin and the slotted guide in the manner of a sliding block which is slidably moved inside the slotted guide. The control pin is either mounted parallel to the rotation axis of the control cam with limited linear movability, or it is has limited swivelability relative to the cardioid slotted guide of the control cam. One swivel axis is here provided stationarily on the carrier structure.

In a further embodiment of the invention, the control pin is arranged on a lever extension extending in the circumferential direction of the control cam and arranged swivelably on a base part fastened to the carrier structure. The lever extension carries the control pin. The base part in turn carries the lever extension.

In a further embodiment of the invention, the base part coaxially surrounds the drive shaft extension and has an axially extending carrier extension on which the lever extension is swivelably mounted. The carrier extension carries the lever extension on which the control pin is arranged. The carrier extension is arranged stationary relative to the base part. In the assembled state ready for operation, the base part is in turn held fixed to the vehicle, such that the carrier extension too is fitted stationarily and hence fixed to the vehicle. Additionally, a control extension may be provided which permanently subjects the lever extension to pressure in the direction of the slotted guide. This control extension prevents any unintended disengagement of the control pin from the slotted guide, which is designed as a slotted guide groove. The control extension also acts as an additional guide for swivelability of the lever extension.

In a further embodiment of the invention, a torsion spring which exerts a permanent torque on the control cam is associated with the control cam. The torsion spring serves to return the control cam, designed as a control roller, into an axial starting position. Advantageously, the resetting spring is designed as a helical compression spring bracing the base part on one side and the control cam on the other.

In a further embodiment of the invention, the push-push control is enclosed by a protective housing which is detachably connected to the carrier structure. This protective housing is preferably designed hood-like or bell-like and prevents fouling of the push-push control. The protective housing encloses the push-push control preferably in the manner of a bell housing.

Further advantages and features of the invention can be found in the claims and in the following description of a preferred example of the invention explained on the basis of the drawing.

### BRIEF DESCRIPTION OF THE DRAWINGS

FIG. 1 shows an embodiment of a function device in accordance with the invention, in particular a rear cover in the area of a rear-side receptacle, fixed to the vehicle, of a towing device for a motor vehicle in a perspective view and in a closed position;

FIG. 2 shows the rear cover according to FIG. 1 with a push-push control in an exploded view;

FIG. 3 shows the rear cover according to FIGS. 1 and 2, omitting a protective housing for the push-push control;

FIG. 4 shows the rear cover according to FIGS. 1 to 3 in an open position of a covering element;

FIG. 5 shows in an enlarged perspective view a section of the rear cover according to FIGS. 1 to 4 in a first function position;

FIG. 6 shows the section according to FIG. 5 in a second function position;

FIG. 7 shows the push-push control according to FIG. 2 in an enlarged exploded view;

FIG. 8 shows the push-push control according to FIGS. 5 to 7 in a further enlarged view; and FIG. 9 shows the push-push control according to FIG. 8 from another perspective.

### DETAILED DESCRIPTION

A motor vehicle has, on the rear side and in the center, a receptacle 2 for a towing device, not shown. The receptacle 2 is formed by a rectangular tube extending in the vehicle longitudinal direction and fixedly connected to rear-side bodywork structure parts of the motor vehicle with the aid of fastening flanges 3 integrally cast in one piece. The receptacle 2 is open to the rear in the vehicle longitudinal direction, wherein this opening is surrounded by a rectangular rim area 4. A rectangular section can be slid into this opening of the receptacle 2 and mechanically secured in the receptacle 2 by a transverse pin. The rectangular section has a ball head or a receiving eyelet or a similar towing element of a towing device.

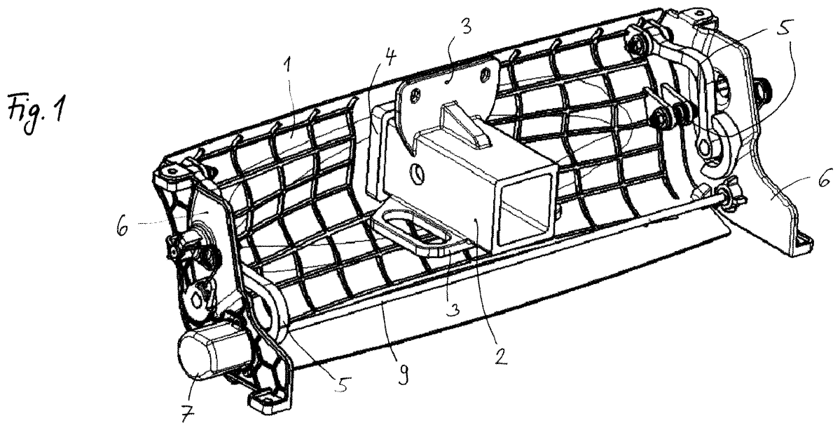

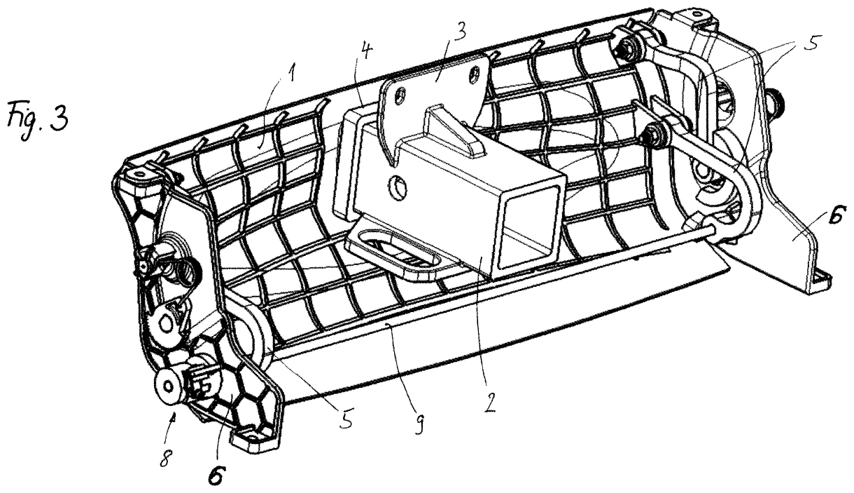

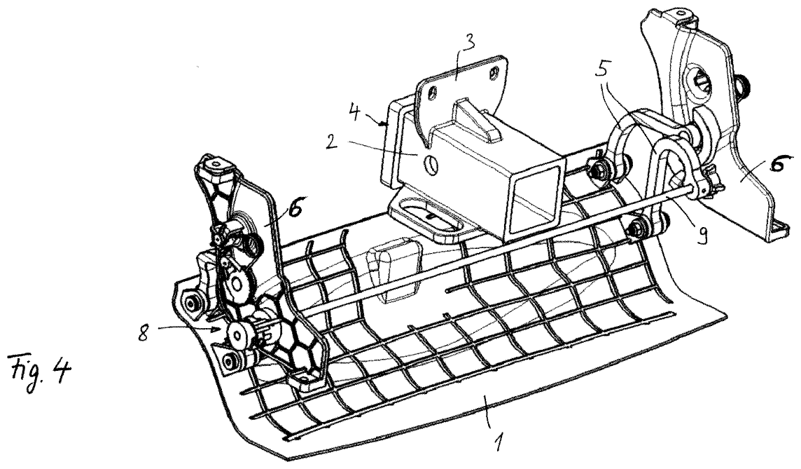

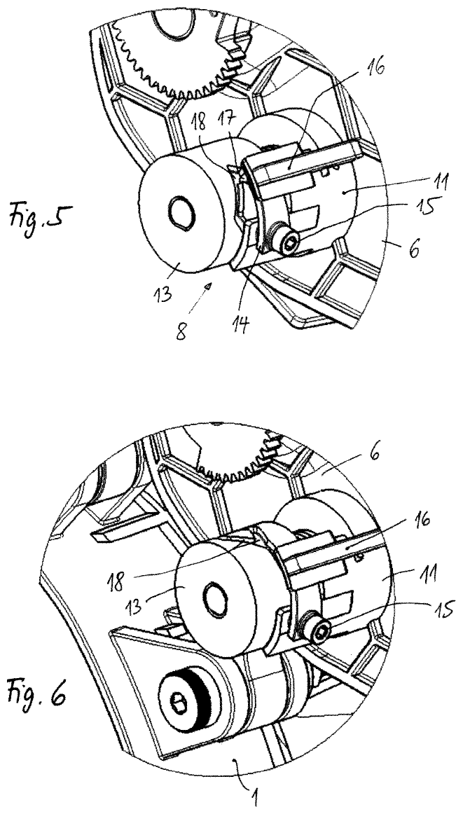

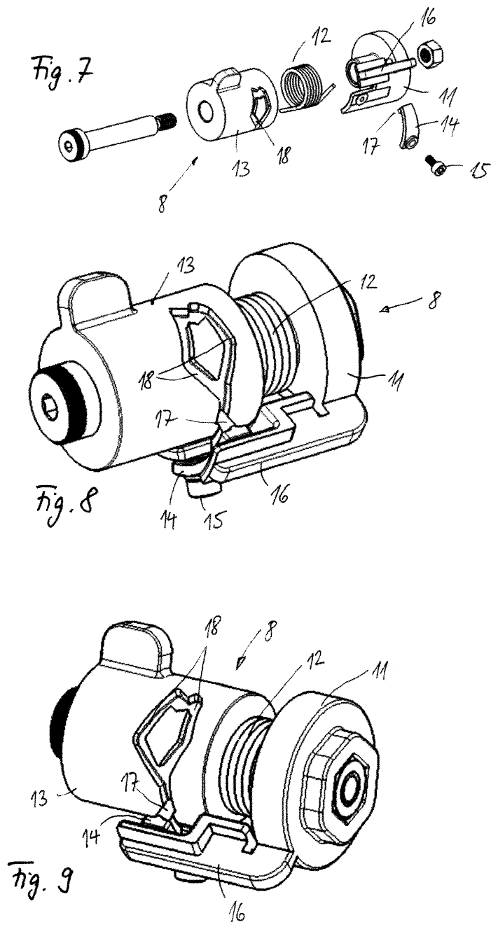

The receptacle 2 and a surrounding rear area of the motor vehicle are closed by a rear cover when the receptacle 2 is not in use, as described in more detail based on FIGS. 1 to 9. The rear cover has a covering element 1 designed as a one-piece, shell-like plastic element having a curved shape discernible from the illustrations in FIGS. 1 to 4. The covering element 1 is mounted movable relative to a carrier structure 6, fixed to the vehicle, between a closed position discernible in FIGS. 1 to 3 and an open position shown in FIG. 4. A control mechanism 5, designed as a four-joint mechanism, is provided for movement of the covering element 1 between the closed position and the open position.

In this connection, the carrier structure 6 has two supporting walls 6 extending in the vehicle longitudinal direction and in the vehicle vertical direction, at a distance to one another in the vehicle transverse direction and flanking the receptacle 2 on opposite sides, these walls being fixedly connected to the rear-side bodywork structure parts. Two control levers of the control mechanism 5 are swivelably mounted on each of the opposite supporting walls of the carrier structure 6 and are swivelable relative to the supporting walls of the carrier structure 6 in swivel planes parallel to one another and created by the vehicle longitudinal axis and the vehicle vertical axis. The control levers are mounted in articulated manner on the covering element 1 with their ends opposite the supporting walls of the carrier structure 6, as may be readily seen in FIGS. 1 to 4. All bearing axes of the articulation points of the control levers of the control mechanism 5 extend here in the vehicle transverse direction.

In the closed position, the covering element 1 closes the opening of the receptacle 2 at the rear-side rim area 4 of the receptacle 2. To do so, the covering element 1 has on the inside, i.e. on its side facing forwards in the vehicle longitudinal direction, a filling element with rectangular cross-section, integrally cast in one piece and not indicated in detail, which in the closed position inserts itself into the rim area 4 of the receptacle 2. This filling element serves to stabilize the covering element 1 in the closed position, since the filling element abuts the inside of the receptacle 2 in the area of the opening of the rim area 4.

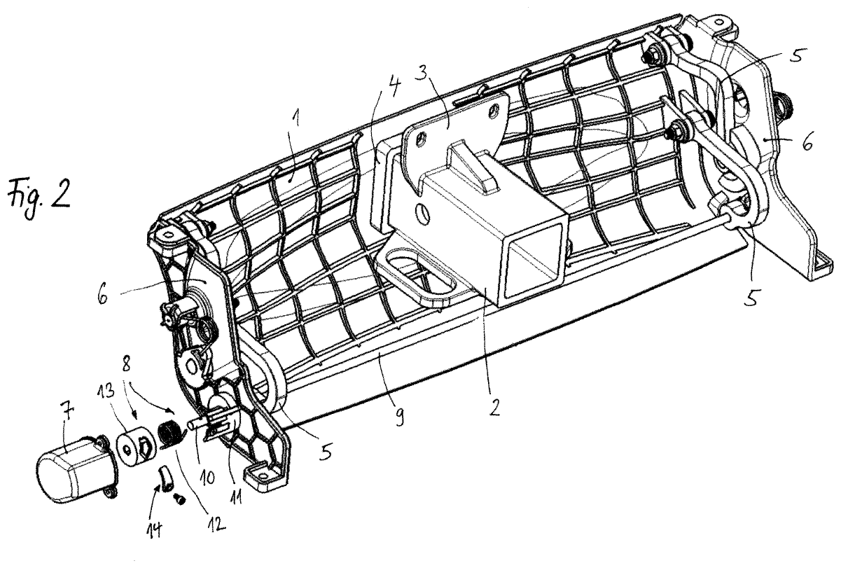

In the example shown, two control levers, opposite one another, of the control mechanism 5 form drive levers in order to move the covering element 1. These are the two control levers which act approximately in the middle of the covering element 1 (the bottom two control levers in the drawing), while the two other control levers act on an upper and inner end area of the covering element 1. The two control levers forming the drive lever are co-rotatingly connected to one another via a drive shaft 9 which extends over the full width of the covering element 1 between the opposite supporting walls of the carrier structure 6. The drive shaft 9 is designed as a cylindrical and straight section and is co-rotatingly connected to both control levers. The drive shaft 9 is rotatably mounted on opposite supporting walls of the carrier structure 6 in opposite bearing blocks, not indicated in detail, about a rotation axis extending in the vehicle transverse direction. On a side on the right when seen in the direction of travel, the drive shaft 9 projects with a drive extension 10 (FIG. 2) through the right-hand supporting wall of the carrier structure 6 and outwards beyond this supporting wall in the vehicle transverse direction. A push-push control 8, described in more detail in the following, is arranged on this drive shaft extension 10.

The push-push control has a control cam 13, designed as a control roller, which has a cylindrical outer contour and is coaxially fitted onto the drive shaft extension 10. The control cam 13 is held co-rotatingly on the drive shaft extension 10. This means that the control cam 13 is rotatable jointly with the drive shaft 9 and with the control levers of the control mechanism 5.

The drive shaft extension 10 is coaxially surrounded by a base part 11, which is fastened to the outside of the supporting wall of the carrier structure 6 and is thus held stationarily. The base part 11 has a cylindrical base which coaxially surrounds the drive shaft extension 10. A cylindrical bush, projecting coaxially outwards, integrally cast in one piece and not indicated in detail, is also provided on the base part 11, on which bush a torsion spring 12 designed as a helical compression spring is held. The torsion spring 12 exerts a permanent torque on the control cam 13.

The control cam 13 has a cylindrical outer circumference which is oriented coaxially to the rotation axis of the drive shaft extension 10. The control cam 13 has on its cylindrical outer circumference a slotted guide 18 in the form of a cardioid slotted guide groove, which extends in the circumferential direction of the control cam 13 as illustrated in FIGS. 8 and 9. A control pin 17, which is fixedly arranged at the end of a lever extension 14 extending in the circumferential direction, engages in this slotted guide 18. The lever extension 14 is swivelably mounted by means of a fastening bolt 15 on a carrier extension, not indicated in detail, of the base part 11, wherein the lever extension extends in the circumferential direction of the control cam 13, whereas the carrier extension extends outwards and axis-parallel to the drive shaft extension in the vehicle transverse direction. The lever extension 14 is designed in the manner of a curved leaf spring and mounted with limited swivelability about a swivel axis defined by a screw axis of the fastening bolt. The lever extension 14 is additionally supported in the area of the control pin 17 by a support extension 16, which is also integrally cast in one piece on the base part 11 and extends outwards parallel to the carrier extension in the vehicle transverse direction. The support extension 16 braces the lever extension 14 radially on the outside, to ensure that the control pin 17 remains permanently positioned in the slotted guide 18. Also, the support extension 16 assists a swivel movement of the lever extension 14.

The push-push control is covered, in the assembled state ready for operation, by a protective housing 7 that consists of plastic and is fitted over the push-push control on the outside of the supporting wall of the carrier structure 6, and is fixedly connected to the supporting wall of the carrier structure 6 with the aid of fastening elements. The fastening elements are designed detachable, such that the protective housing 7 can be removed again if required.

In the closed position of the covering element 1, the control pin 17 is in contact with the V-shaped upper locking receptacle of the cardioid slotted guide 18, i.e. in a first end position. If the covering element 1 is now moved, by brief manual pressure from the hand of an operator, from the rear in the opposite direction to the subsequent opening movement of the covering element 1, the control pin 17 leaves the V-shaped receptacle and slides in the circumferential direction along a section of the cardioid slotted guide 18 in the direction of the lower groove end of the slotted guide 18 shown in FIGS. 8 and 9, until the control pin 17 comes into contact with the end of the groove of the slotted guide 18. This groove end forms the second end position, i.e. the other locking receptacle for the control pin 17. The corresponding rotary movement of the control cam 13 corresponds to a rotary movement of the drive shaft 9 between the closed position and the open position, so that in the function position shown in FIGS. 8 and 9, the control pin 17 also defines the open position of the covering element 1. This is because the control cam 13 has, due to a corresponding counter-clockwise rotation of the drive shaft 9, also been co-rotated due to the co-rotating connection to the drive shaft 9. This end position of the control pin 17 thus defines the open position of the covering element 1. If the covering element 1 is then to be moved again in the direction of the closed position, an operator simply grips the covering element 1 from the rear and pulls it upwards. The control cam 13 is here necessarily rotated clockwise, i.e. opposite to the opening direction. As soon as the control pin 17 has reached one of the two corner edges of the V-shaped section of the slotted guide 18, the manual setting force being applied to the covering element 1 can be removed. This is because the torsion spring 12 then necessarily rotates the control cam 13 back again, such that the control pin 17 again inserts itself into the V-shaped section of the slotted guide 18. The closed position of the covering element 1 is reached again and is secured by the firm seating of the control pin 17 in the V-shaped section of the cardioid slotted guide 18.

The push-push control 8 accordingly activates the drive shaft 9 and hence the control mechanism 5 in the direction of the closed position or open position, and hence in both rotation directions. Also, the push-push control 8 positively Secures the corresponding end positions, i.e. the closed position and the open position, of the covering element 1 by appropriate engagement of the control pin 17, either in the V-shaped section of the cardioid slotted guide 18 or into the pointed lower end of the groove of the cardioid slotted guide 18, which each form locking receptacles.

1. A function device for a motor vehicle for a rear-side receptacle, fixed to the motor vehicle, of a towing device, the function device comprising:
a carrier structure fixed to the motor vehicle;
a control mechanism mounted on the carrier structure;
a function part mechanically coupled to the control mechanism and movable between two different end positions by the control mechanism; and
a push-push control associated with the control mechanism and locking the function part in either of the two end positions or releasing the function part for transfer to the other end position.

2. The function device according to claim 1, wherein the push-push control is configured for rotation.

3. The function device according to claim 2, wherein the control mechanism comprises a rotatable drive shaft extension and the push-push control is associated with the rotatable drive shaft extension of the control mechanism.

4. The function device according to claim 3, wherein the push-push control has a control cam with an outer circumference, the control cam co-rotating with the drive shaft extension), the control cam comprising a cardioid slotted guide on the outer circumference.

5. The function device according to claim 4, wherein the outer circumference of the control cam is cylindrical, and the cardioid slotted guide comprises a slotted guide groove in the cylindrical outer circumference.

6. The function device according to claim 5, wherein the push-push control has a control pin projecting into the cardioid slotted guide and mounted with limited back-and-forth movability.

7. The function device according to claim 6, further including a lever extension and a base part fastened to the carrier structure, the control pin being arranged on the lever extension, extending in a circumferential direction of the control cam and being arranged swivelably on the base part.

8. The function device according to claim 7, wherein the base part coaxially surrounds the drive shaft extension and has an axially extending carrier extension, the lever extension being swivelably mounted on the carrier extension.

9. The function device according to claim 4, further including a torsion spring exerting a permanent torque on the control cam.

10. The function device according to claim 1, further including a protective housing detachably connected to the carrier structure, the push-push control being enclosed by the protective housing.

11. The function device according to claim 1, wherein the function device comprises a rear cover for the rear-side receptacle of the motor vehicle.

12. The function device according to claim 11, wherein the function part comprises a covering element.
